(19) United States
(12) Patent Application Publication
(10) Pub. No.: US 2003/0062061 A1
(43) Pub. Date: Apr. 3, 2003

(54) Safe dental floss

(76) Inventor: Tung-Shan Lee, Lujou City (TW)

Correspondence Address: DOUGHERTY & TROXELL, 5205 LEESBURG PIKE, SUITE 1404, FALLS CHURCH, VA, 22041, US

(21) Appl. No.: 09/964,324

(22) Filed: Sep. 28, 2001

(51) Int. Cl. A61C 15/00

(52) U.S. Cl. 132/321

(57) ABSTRACT

A safe dental floss consists of a bundle of slender fiber strings and an outer surrounding layer surrounding the bundle of slender fiber strings. The outer surrounding layer is made of a kind of slipping substance such as rubber. Then the dental floss may reduce mutual friction against two teeth between a gap where the dental floss is pushed in and moved inward and outward to clean remains left therein. Therefore, the dental floss may not liable to break or pinch a tooth, very safe to use.

### BACKGROUND OF THE INVENTION

This invention relates to a safe dental floss, particularly to one safe to use and not pinch a tooth in using for cleaning a gap between two teeth.

A common conventional dental floss 10 shown in FIGS. 1 and 2 is a bundle of fiber strings 11, with each fiber string not adhered together at all, only put together and then provided between two parallel rods extending from a handle.20

When the common conventional dental floss 10 is forced into a gap 31 between two teeth 30, it is moved inward and outward in the gap 31 for removing food remains left in the gap 31. Provided the dental floss 10 has a large diameter, difficult to move into the gap 31, most users may forcefully pushes the dental floss into the gap 31. As the dental floss 10 is made of a plurality of slender fiber strings 11 to form a bundle, the bundle may lose its bundling force to let one or more slender fiber strings 11 cut or broken by forceful mutual friction between the teeth and the dental floss 10. After many times of repeated movements of the dental floss, all the slender strings 11 may be cut and stay in the gap 31, very troublesome.

### SUMMARY OF THE INVENTION

This invention has an objective of offering a safe dental floss having an outer surrounding layer surrounding a bundle of a plurality of slender fiber strings for not pinching a tooth, and the surrounding layer provided with slipping feature so that the dental floss may rub with little friction during the dental floss moving in a gap between two teeth. Then the dental floss may not so easily cut or break to effect cleaning the gaps between every two teeth.

The feature of the invention is a slippery outer surface of the outer surrounding layer, and a dental floss provided with the outer surrounding layer has a plurality of slender fiber strings bundled together and surrounded by the outer surrounding layer, which then prevents the dental floss from breaking or pinching a tooth so as to let it safe to use.

### BRIEF DESCRIPTION OF DRAWINGS

This invention will be better understood by referring to the accompanying drawings, wherein:

FIG. 1 is an enlarged cross-sectional view of a known conventional dental floss;

FIG. 2 is a side view of the conventional dental floss fixed between two parallel rods of a handle.

FIG. 3 is a cross-sectional view of the conventional dental floss forced in a gap between two teeth;

FIG. 4 is a side view of the conventional dental floss with its slender fiber strings broken in a gap between two teeth;

FIG. 5 is an enlarged cross-sectional view of a dental floss in the present invention;

FIG. 6 is a side cross-sectional view of the dental floss forced in a gap between two teeth; and,

FIG. 7 a side cross-sectional view of the dental floss moving in a gap between two teeth in the present invention.

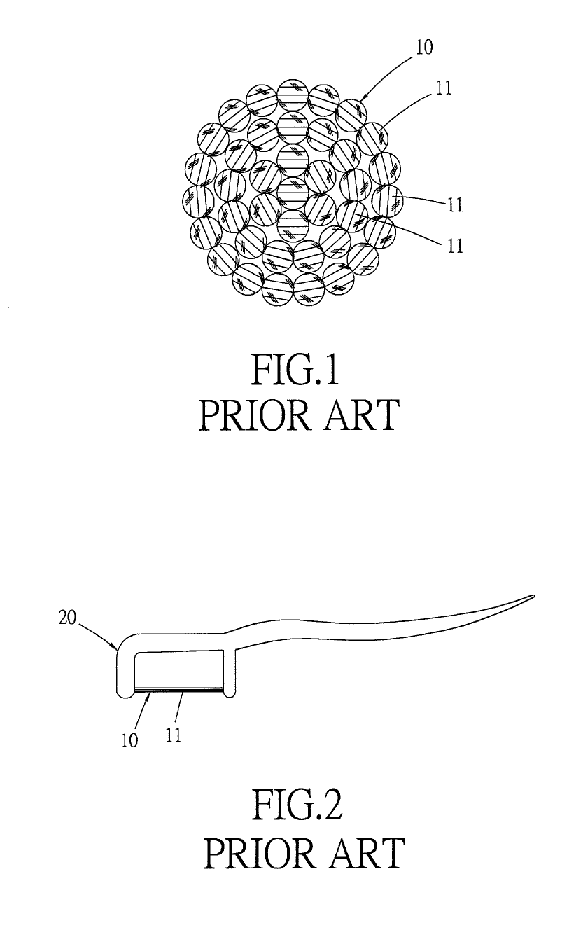

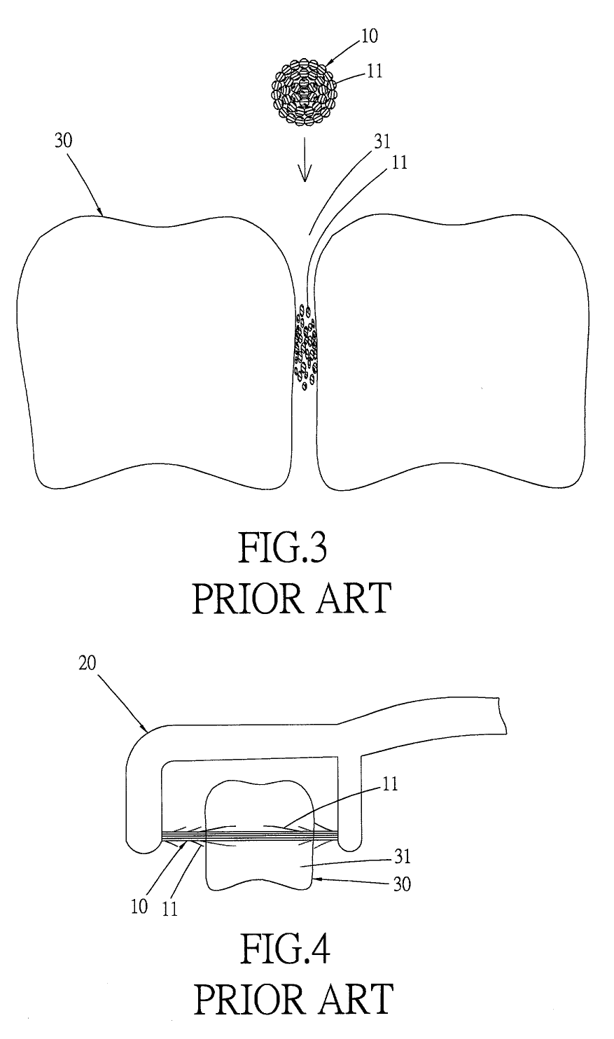

### DETAILED DESCRIPTION OF THE PREFERRED EMBODIMENT

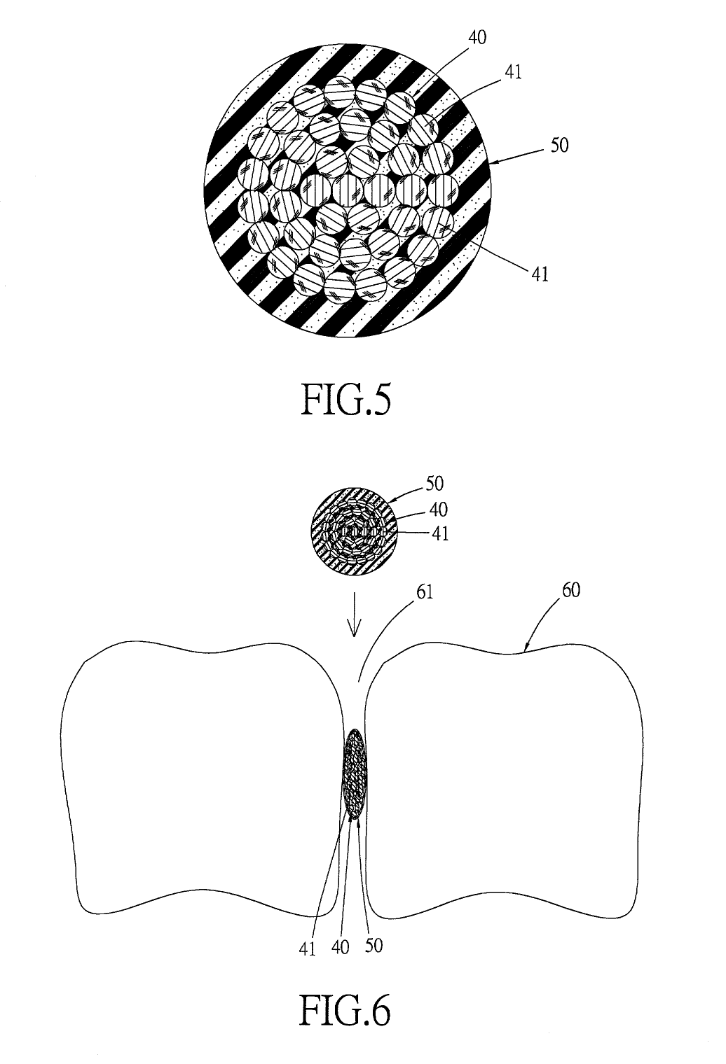

A preferred embodiment of a safe dental floss 40 in the present invention, as shown in FIG. 5, is made of a plurality of slender fiber strings 41 bundled together, and kept extended between two parallel rods of a handle 20.

A critical improvement of the dental floss 40 is an outer surrounding layer 50 made of edible substance completely covering around the bundle of slender fiber strings 41. The outer surrounding layer 50 has a property of substantially slipping and is mixed or coated in advance with a little sterilizing chemicals such as iodine or the like, enabling the outer surrounding layer have effect of sterilization as well.

In using the dental floss in the invention, referring to FIG. 6, a user pushes the dental floss 40 in a gap 61 between two teeth 60 and move inward and outward therein to remove food remains left therein in the same way the conventional one is used. However, the dental floss 40 has the outer surrounding layer 50 in addition to dental floss 40, and the shape of dental floss 40 may change according to the width of the gap 61 because of slipping feature of the outer surrounding layer 50 to lessen mutual friction between the outer surrounding layer 50 and the teeth 60. Then the dental floss 40 of the invention can smoothly and comfortably slides into a gap 61 between two teeth.

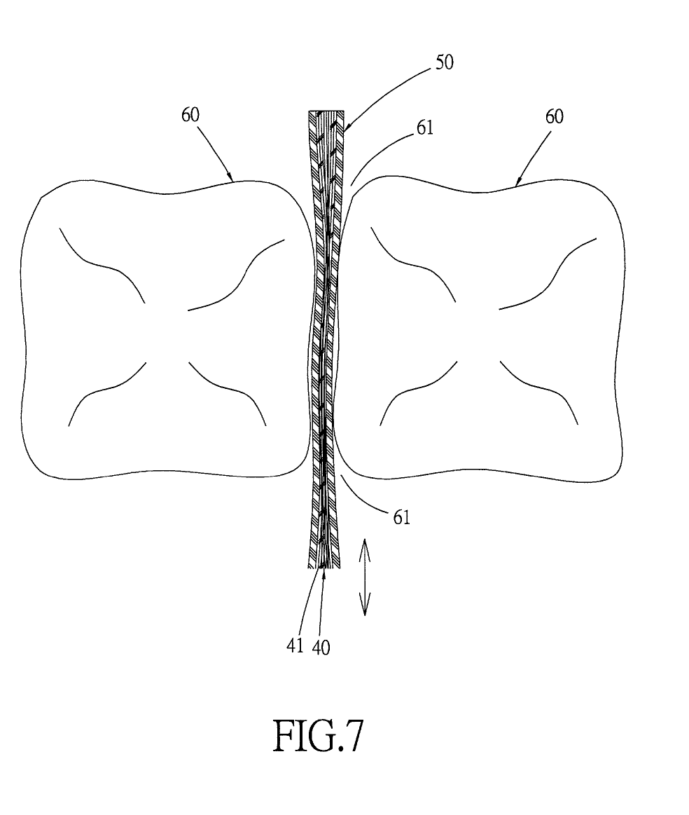

Next, referring to FIG. 7, the outer surrounding layer 50 completely covers the slender fiber strings 41, which is still kept in the surrounding layer 50 even when the dental loss is pushed in the gap 61 so that the bundling force still exits to prevent the slender fiber strings 41 from breaking in moving outward and inward of the dental floss, with the outer surrounding layer contacting with the teeth with the whole structural strength. So the plurality of the slender fiber strings 41 or the dental floss 40 can avoid being cut or broken during cleaning movement of the gap 61. Besides, the dental floss 40 may not hurt or damage teeth but elevate comfortableness in using.

Further, the outer surrounding layer 50 may be made of adhesive substances such as silicon rubber or chewing gum material to attain slipping and smooth effect.

In general, it is worth to s ay that the outer surrounding layer 50 of the dental floss 40 in the invention can not only get rid of breaking of a dental floss, but also make use of the special slipping material coated on the outer surrounding layer 50 to smoothing inward and outward movement of the dental floss.

While the preferred embodiment of the invention has been described above, it will be recognized and understood that various modifications may be made therein and the appended claimed are intended to cover all such modifications that may fall within the spirit and scope of the invention.

I claim:

1. A safe dental floss comprising a bundle of slender fiber strings and an outer surrounding layer surrounding said bundle of slender fiber strings, said outer surrounding layer having slipping feature.

2. The safe dental floss as claimed in claim 1, said outer surrounding layer is made of an adhesive substance.

3. The safe dental floss as claimed in claim 1 or 2, wherein said outer surrounding layer is made of a kind of edible chewing gum.

4. The safe dental floss as claimed in claim 1 or 2, wherein said outer surrounding layer is made of a silicon rubber.

5. The safe dental floss as claimed in claim 1, wherein said outer surrounding layer contains a micro quantity of sterilizing chemical.

6. The safe dental floss as claimed in claim 5, wherein said sterilizing chemical is iodine.

7. The safe dental floss as claimed in claim 1, wherein said outer surrounding layer directly covers an outer circumference of said bundle of slender fiber strings to form as integral with the outer surrounding layer.
